(19) United States
(12) Patent Application Publication
(10) Pub. No.: US 2011/0201250 A1
(43) Pub. Date: Aug. 18, 2011

(54) FINGERBOARD SKATEBOARD

(76) Inventor: JOREMY FOX, Huntington Beach, CA (US)

(21) Appl. No.: 13/094,614

(22) Filed: Apr. 26, 2011

Related U.S. Application Data
(63) Continuation of application No. 12/030,753, filed on Feb. 13, 2008, now Pat. No. 7,931,519.
(60) Provisional application No. 60/889,846, filed on Feb. 14, 2007.

(51) Int. Cl. A63H 17/26; B23P 11/00

(52) U.S. Cl. 446/470; 29/428

(57) ABSTRACT

A finger-operated miniature skateboard toy with a release agent is provided for simulating skateboard maneuvers, commonly performed on a full-sized conventional skateboard, on a miniature level substituting a user's fingers for a rider's feet with the skateboard toy including a miniature skateboard deck and a plurality of wheels and the release agent enabling a first portion of the skateboard deck to be flexed relative to another portion of the skateboard deck to increase traction between a user's finger and the skateboard deck and further enabling the skateboard deck and at least one wheel to launch off an underlying support surface whereby a user may simulate tricks such as an “ollie” maneuver and other tricks allowing for the performance of different skateboarding tricks that are typically not successful with a conventional fingerboard skateboard.

This application is a continuation of application Ser. No. 12/030,753, filed on Feb. 13, 2008, now U.S. Pat. No. 7,931,519, which claims the benefit of U.S. Provisional Application No. 60/889,846, filed on Feb. 14, 2007, both of which are hereby incorporated by reference in their entireties.

### BACKGROUND OF THE INVENTION

1. Field of the Invention

The invention relates generally to the field of amusement and recreational devices. More specifically, the present invention relates to miniature finger-operated toy skateboards.

2. Background

Skateboarding as a sport was first started in the United States around the 1950s. Typically, it was a result of California surfers' desire to surf on the streets. Skateboards originated as wooden boxes or boards with roller skate wheels slapped to the bottom. Because of this rudimentary design, many skateboarders were injured during this period. Eventually, the boxes turned into other types of wood including pressed wood and the like.

However, after a decade, the popularity of skateboarding began to subside. Many toy experts assumed that the sport/toy was a fad and that the fad had run its course, whereby most young people weren't into the sport any longer. However, there were those that continued the tradition of skateboarding, although much fewer in numbers.

Later in the evolution of skateboarding, a development was made in skateboard technology, which saw the invention of the urethane skateboard wheel, which is still used today.

The skateboards also evolved from simple wooden boxes to shaped boards with accompanying tails. Boards that are in the market are now constructed to have no clear front or back side, thereby allowing a skateboarder to ride either way on the board more easily. The wheels of a skateboard began as metal roller skate wheels, to rubber wheels, and eventually to lighter and cheaper urethane wheels.

Boards have continued to evolve, as companies try to make them lighter and stronger, and continue to try to improve on their performance. As skateboards developed and improved in performance, the popularity of skateboarding began to grow again. One thing that has remained constant through the last fifty years is that skateboarding has always been about personal discovery and pushing oneself to the limit.

In addition to merely riding a skateboard, a primary objective for many skateboarders is learning and developing new tricks that incorporate the skateboard. One of the most popular types of skateboard trick, commonly referred to as an “ollie”, is a maneuver performed on the skateboard while skateboarding. This type of trick is a jumping move using the rider's legs and foot coordination to elevate the skateboard above the ground without the need for the rider to use their hands. Additionally, the ollie trick is to be performed without the need for any additional gear including straps or foot holding devices. Learning and perfecting new tricks derived from these “ollie” maneuvers is the major goal of many skateboarders.

Arising from the popularity of skateboarding, a miniaturized toy skateboard, also known as a fingerboard or fingerboard skateboard, has been developed in response to a perceived need in the toy market. The fingerboard generally incorporates similar components to the full-sized, rider-bearing skateboards such as a skateboard deck with opposing front and rear trucks attached to its undersurface. Each truck also includes an axle with a pair of associated wheels capable of rolling over underlying surfaces. However, unlike a full-sized skateboard that bears a rider's weight and provides sufficient surface area for both of the rider's feet and also gains its locomotive power primarily through a pedaling action, the fingerboard skateboard is maneuvered using one's fingers. In use, the user attempts to simulate with the fingerboard many of the same motions and tricks used by full-sized skateboard riders including rolling over flat underlying surfaces, sliding along ramps, rails, and curbs, and flipping and jumping. However, in particular, the ollie maneuver is very difficult to replicate with a hand while playing with a conventional fingerboard. The intricate motions afforded by a skateboard rider's leg and foot movements are practically impossible to replicate with a user's hand and/or finger movements. The inherent restrictions in hand and finger movements in performing the ollie with a fingerboard, lead to difficulty in maintaining traction with the finger as is done using the front foot on a full size skateboard.

Thus, a need exists for an improved, yet easy to use, finger-operated skateboard entertainment device that enables a user to simulate and perform common skateboard maneuvers and tricks normally produced on a traditional, full-sized skateboard, and, in particular, enhance the user's ability to simulate and perform traditional skateboard tricks on the finger-operated skateboard based upon a simulated “ollie” maneuver.

### SUMMARY OF THE INVENTION

The present invention relates to a finger-operated entertainment device operable to execute traditional skateboard maneuvers and tricks on a miniature level. The device may be provided in the form of a toy fingerboard skateboard with a miniature skateboard deck having at least a top surface adapted for engagement by the fingers of an individual and further including a plurality of wheels for rolling or sliding over underlying surfaces such that the fingerboard may be propelled and manipulated by the user's finger or fingers to perform skateboard tricks commonly performed using full-sized skateboards by substituting the user's fingers for the user's feet. The device incorporates a release agent located in one or more portions of the skateboard deck allowing for a downward pressure to be applied to one portion of the skateboard deck by a user's finger to increase the traction between another portion of the skateboard deck and a user's finger applied thereto and may further elevate a portion of the skateboard off an underlying support surface. The release agent may also assist in lifting off or launching the wheels from an underlying surface when the pressure is released from at least one portion of the skateboard deck. The increased traction and pressure between the skateboard deck and the user's fingers as well as the launch feature of the skateboard, as enhanced by the release agent, allows for the performance of different miniature skateboarding tricks with a visual authenticity matching or closely approximating the same tricks performed using a full-sized skateboard that would otherwise be difficult or impossible using a conventional fingerboard.

In accordance with principles of the present invention, the release agent may be in the form of a spring click mechanism, hinge, flexible fiber, spring, spring means, spring clip, spring mechanism, attachment mechanism, flexion mechanism, and/or similar mechanism allowing one portion of the skateboard deck to flex relative to another portion of the skateboard deck.

In at least one embodiment of the present invention, the release agent may be located in the front portion of the fingerboard, between the front and middle portions of the fingerboard, in the rear portion of the fingerboard, between the rear and front portions of the fingerboard, or between the rear and middle portions of the fingerboard. Such release agent may be used to attach adjacent portions of the fingerboard as well as to provide the flex feature. The release agent may be integrally built into portions of the fingerboard or coupled thereto.

In at least one exemplary embodiment, the device has a release agent that couples the rear portion of the skateboard deck to a front portion of the skateboard deck and that allows for flexion of the rear portion of the skateboard relative to the front portion of the skateboard.

In other exemplary embodiments, the device has a plurality of wheels that may be positioned on a bottom side of the board with a first set of wheels positioned beneath the bottom side of the front portion of the skateboard, and a second set of wheels may be positioned beneath the bottom side of the rear portion of the skateboard or all wheels may be positioned in the front portion of the skateboard. The wheels may be placed fore of the release agent or aft of the release or fore and aft of the release agent.

In at least one exemplary embodiment, the device has at least one axle attached to the plurality of wheels with the axles are selected to allow either independent movement of the wheels relative to one another or for preventing movement of a pair of wheels relative to one another.

In at least one exemplary embodiment, the device further has an attachment mechanism between the release agent and the side portion of the fingerboard skateboard.

Still another exemplary embodiment of the present invention is provided by a fingerboard skateboard whereby a hinge, spring click or similar mechanism may be incorporated into at least a portion of the board to allow for greater pressure to at least one portion of the board to increase traction and maneuverability of the board with the fingers of a user.

Yet another exemplary embodiment of the present invention is provided by a fingerboard skateboard whereby a hinge, spring click or similar mechanism may be incorporated into at least a portion of the board to increase and release the tension afforded to a finger, by the corresponding pressing and release of the finger on the spring clip, hinge or similar mechanism loaded portion or portion adjacent thereto.

Still another exemplary embodiment of the present invention is to provide a fingerboard skateboard with a hinge, and/or spring allowing for flexion of the board at a particular portion of the board thereby allowing for greater pressure at a set location on the fingerboard skateboard.

Yet another exemplary embodiment of the present invention provides a fingerboard skateboard with a spring, hinge or other flexion mechanism whereby the spring, hinge or other flexion mechanism may allow for flexing and increased pressure to be placed on either the front portion or the rear portion of the fingerboard skateboard.

In yet another exemplary embodiment of the present invention a fingerboard skateboard is provided with a spring, hinge or other flexion mechanism whereby the spring, hinge or other flexion mechanism may be incorporated into the structure of the fingerboard skateboard and may be utilized by a single finger of a user to create more tension, pressure and friction which would closely simulate the tension, pressure and friction created by a real user utilizing a real skateboard.

Methods of constructing and using a finger operated skateboard entertainment device relating to the sport of skateboarding and performing common skateboard tricks on a miniature scale is also provided herein.

One object of at least one embodiment of the present invention is to provide a miniature finger-operated skateboard, commonly known as a fingerboard, whereby a common skateboard trick referred to as an ollie may be easily performed on the miniature fingerboard skateboard by utilizing a release agent in the tail portion or section of the fingerboard thereby giving greater traction between the skateboard deck and the user's finger during use.

Another object of at least one embodiment of the present invention is to provide a miniature finger operated skateboard whereby the fingerboard skateboard may allow for increased pressure to be applied to the rear section of the fingerboard thereby allowing the user to more closely duplicate the traditional tricks that may be performed or executed by a standard traditional, full size skateboard.

Another object of at least one embodiment of the present invention is to provide a fingerboard skateboard whereby the toy may allow for a similar result to the performance of a skateboard trick as may result from a real full size board.

Another object of at least one embodiment of the present invention to provide a fingerboard skateboard toy whereby the toy may allow for a more substantial and authentic feel to performing a traditional skateboard trick on a miniature scale.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a left side, upper, perspective view of an exemplary finger-operated skateboard toy device, commonly referred to as a fingerboard or fingerboard skateboard, in accordance with a first embodiment of the present invention;

FIG. 2 is a rear, upper perspective view of the fingerboard device of FIG. 1;

FIG. 3 is a top plan view of another exemplary embodiment of the fingerboard device in accordance with the present invention;

FIG. 4 is a bottom view of the fingerboard device of FIG. 1; and

FIG. 5 is a similar view to FIG. 1 depicting a user's fingers engaging the exemplary fingerboard device.

### DETAILED DESCRIPTION OF THE PREFERRED EMBODIMENTS

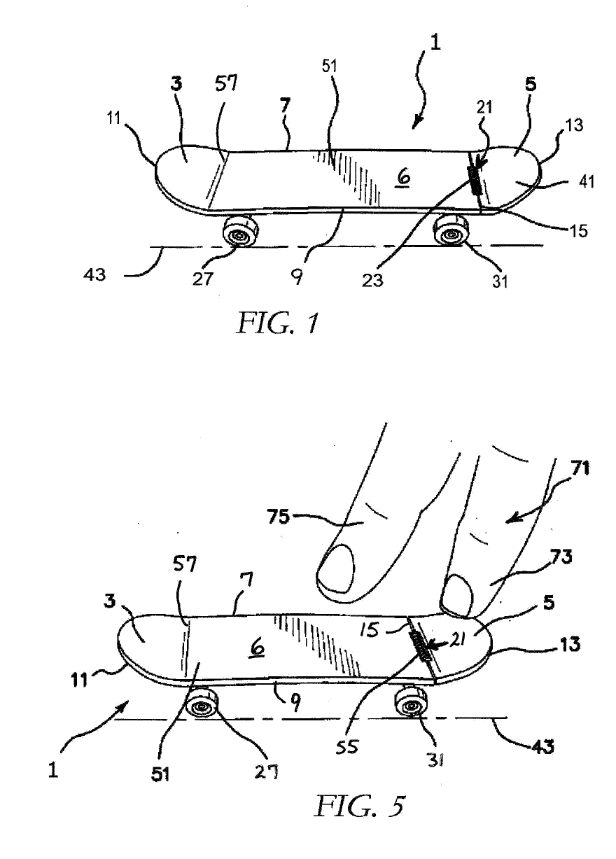

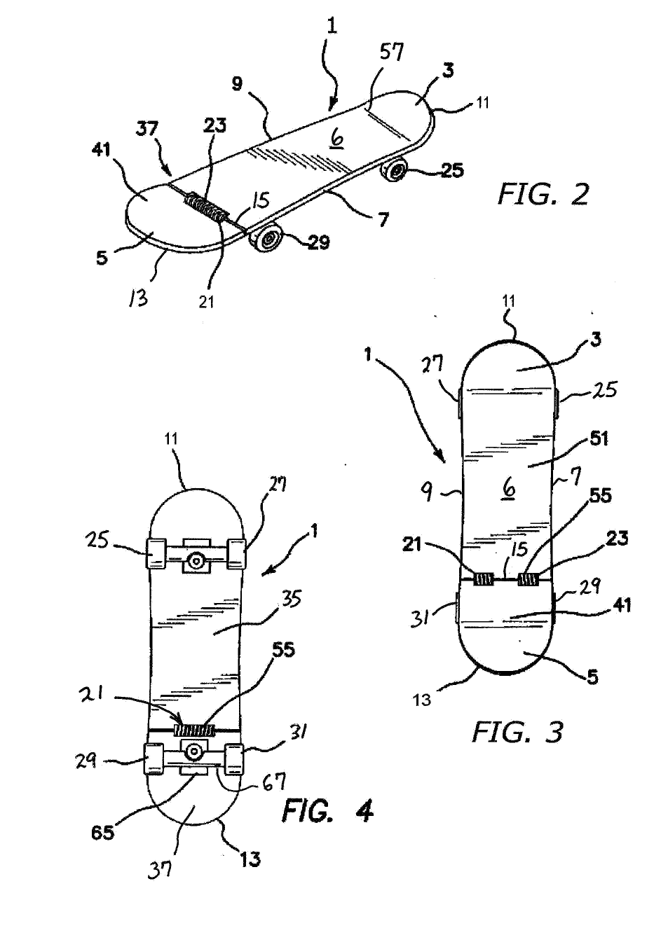

Referring now to FIGS. 1-2, an exemplary, first embodiment of a fingerboard skateboard, generally designated 1, is illustrated. As shown in FIG. 1, the fingerboard skateboard 1 generally includes a miniature skateboard deck with an elongated front nose portion 3 and a shortened rear (or tail kick) portion 5. It will be appreciated that section and portion are used interchangeably herein. Spanning between the front nose portion and the tail kick portion is an elongated main (middle or intermediate) planar portion 6 including a first side portion 7 and an opposing second side portion 9. The side portions may be parallel to one another, present a tapered appearance, or include a contoured region when viewed from above.

As shown in FIG. 1, both the nose section 3 and the tail kick section 5 are upturned from the middle section 6 with the nose section 3 terminating at a curved and/or tapered front edge 11 and the tail kick 5 portion terminating in a curved and/or tapered back edge 13 as is typical of a conventional full-sized skateboard. The skateboard deck including the nose portion, rear portion, and middle planar portion may be constructed of wood, metal, plastic, polyurethane, or any other suitable resilient material to simulate the rigidity or flexibility of a full-sized skateboard on a miniature scale.

With continued reference to FIGS. 1-2, the rear portion 5 of the fingerboard 1 is attached to the back edge 15 of the first side portion 7 and the second side portion 9. The rear portion 5 may be attached to the rear edge 15 by a release agent, generally designated 21, that may also provide a means for attaching the rear tail kick portion 5 to the middle portion 6 of the fingerboard 1 as well as a device for enabling the rear tail kick portion to be flexed related to the middle or front portions of the fingerboard. Thus, the release agent and means for attaching adjacent portions of the skateboard deck may be one in the same or discrete elements, although preferably one in the same. In one exemplary embodiment, the release agent 21 may be a hinge 23 (FIGS. 1-2). However, other contemplated release agents include a flexible fiber, a spring, a spring click mechanism, spring means, spring mechanism, spring clip, attachment mechanism, flexion mechanism, a spring, and/or similar mechanism or any other means that would allow for flexion on one portion of the skateboard deck relative to another. Each such release agent allows for the loading of stored energy when moved or rotated from a pre-loaded configuration to a loaded configuration and also biases the adjacent portions of the skateboard toward one another when flexing is applied. In this exemplary embodiment, the release agent allows for flexion of the rear portion 5 of the skateboard 1 relative to the middle portion 6 or front portion 3. As illustrated in FIG. 3, the release agent 21 may include more than one spring, hinge, flexible fiber, or flexion element as shown by the spaced apart release agents that couple the rear portion 5 to the middle portion 6 of the fingerboard 1.

With the use of the release agent 21, the rear portion 5 is able to flex with the pressure that may be applied by a user's finger or fingertip to utilize the fingerboard skateboard to perform certain tricks with the skateboard 1 while in use. It will be appreciated that the release agent enhances the range and effectiveness of available trick options available to the user. The release agent 21 may allow for sufficient flexion of the rear portion 5 relative to the front portion 3 and/or middle portion 6 whereby the rear portion 5 may pivot vertically under pressure from a user's finger which may cause the front portion 3 and middle portion 6 of the fingerboard skateboard 1 to elevate off of a flat surface corresponding to the pressure on the rear portion 5 of the board 1. It will be appreciated the front portion 3 and middle portion 6 may be positioned fore of the release agent may be collectively referred to as the front portion of the fingerboard while the rear tail kick portion 7 or portion aft of the release agent may be referred to the rear portion.

FIG. 2 illustrates a rear upper perspective view of the fingerboard skateboard 1 that also illustrates the rear portion 5, the front portion 7 and the corresponding middle portion 6 with side portions 7, 9. Additionally, as shown in FIG. 2, the fingerboard skateboard 1 may have a plurality of wheels including a first (front right as viewed from the top in FIG. 3) wheel 25, a second (front left) wheel 27, a third (rear right) wheel 29 and a fourth (rear left) wheel 31. The wheels may be constructed of metal, wood, plastic, polyurethane, or other suitable material.

As further illustrated, the fingerboard skateboard 1 may have a first and second wheel, together the front wheels 25, 27, respectively, which are coupled together on the bottom side 35 of the front portion 3 or middle portion 6 of the fingerboard 1. Moreover, the third and fourth wheel, together the rear wheels, 29, 31, respectively, may be coupled together on the bottom side 35 at or near the rear edge 15 of the front portion 3 of the fingerboard skateboard 1 such as in FIGS. 1-2 and 5. However, it is also contemplated that the third and fourth wheels 29, 31, respectively, may also be positioned on the bottom side 37 of the rear portion 5 as shown in FIG. 4 for example. However, in the preferred embodiment, the wheels 29, 31 are located on the bottom side 35 of the front portion 3 as shown in FIGS. 1-3 and 5. The advantage of this preferred placement may be that when sufficient pressure is put on the top side 41 of the rear portion 5 which is hingeably attached to the front portion 3, the flexion of the rear portion 5 may allow the third and fourth wheels 29, 31 to stay in constant contact with an underlying substantially flat surface 43, while the first and second wheels 25, 27 may be elevated away from the flat surface 43 unless also prevented from elevating by a user's finger. Additionally, it is contemplated that either of the third and/or fourth wheels 29, 31, respectively, may be adaptable for movement independent of each other. For example, if a user (not shown) wishes to execute a skateboard 1 trick that requires the fingerboard skateboard 1 to flip, it may require the first and third wheels 25, 29 to elevate relative to the flat surface 43 while the second and fourth wheels 27, 31 are in communication with the flat surface until at least a portion of the flip exercise has begun, thereby causing the second and fourth wheels 27, 31 to move in conjunction with the first and third wheels 25, 29 whereby the entirety of the wheels are elevated and/or removed from contact with the flat surface while the trick is being performed.

FIGS. 3 and 4 illustrate the top side 51 and the bottom side 35 of the front and middle portions 3, 6, respectively, and bottom side 37 of the rear portion 5 of the fingerboard skateboard 1. As illustrated in FIG. 3, the top side 51 of the fingerboard skateboard may have a rear portion 5 that may be wider than the width of the front portion 3. The advantage to having an increased width portion is such that a user may utilize the rear portion 5 more effectively with their finger when in use as an increased finger engagement surface is provided. Additionally, as illustrated in FIG. 3, the release agent 21 may provide an attachment means that allows for hinged pivoting of the rear portion 5 about the front portion 3 of the fingerboard skateboard 1. In one exemplary embodiment, the attachment means 21 may be a spring mechanism 55 (FIGS. 4-5) similar in function to the hinge mechanism described above. The spring mechanism 55 may attach the rear portion 5 of the fingerboard skateboard 1 to the front portion 3 of the fingerboard skateboard 1. The spring mechanism 55 may also allow for pivoting of the rear portion 5 in a vertical fashion extending both away from the flat surface 43 directly after disengagement of the user's finger (73 or 75 in FIG. 5) from the rear portion 5 and when engaged by the user's fingers, the pressure on the rear portion 5 may cause the spring to extend allowing flexion of the rear portion 5 towards the flat surface 43 (FIG. 5).

The spring mechanism 55 is further illustrated in FIG. 4, which shows the bottom sides 35, 37, of the respective portions 3, 5 of the fingerboard skateboard 1. Additionally, FIGS. 1-5 illustrate the first and second wheels 25, 27 positioned in close proximity to the front edge 57 of the middle portion 6 of the board where the upturned section of the front portion 3 begins and the third and fourth wheels 29, 31 positioned in close proximity to the rear edge 15 of the front portion 3 of the fingerboard skateboard 1. However, it should be understood that the third and fourth wheels 29, 31, in an exemplary embodiment, may be located aft of the back edge 15 of the front portion 3 as in FIGS. 3-4 or fore of the back edge of the front portion as in FIGS. 1-2, and 5. Additionally, as illustrated in FIG. 4, the rear wheels may contain a truck 65 with an axle 67 whereby the axle may allow for independent movement of the wheels 29, 31 relative to each other. It is contemplated in an exemplary embodiment that the axle 65 may allow for movement of the wheels 29, 31 in combination. A similar truck and axle combination may be used for the front wheels 25, 27.

FIG. 5 illustrates the fingerboard skateboard 1 in use. With a fingerboard skateboard 1 provided, as illustrated in an exemplary embodiment, a user, generally designated 71, may utilize at least a first finger 73 which may be the pointer finger, and a second finger 75 which may be the middle finger. However, it should be contemplated that any finger may be utilized in order to operate the fingerboard skateboard 1. The user 71 may position the first finger 73 on a position at the front portion 3 or middle portion 6 of the fingerboard skateboard 1 and the second finger 75 may be positioned on the rear portion 5 of the fingerboard skateboard 1. Typically, the user's fingers will be placed on a top portion of the fingerboard but the sides and underside of the fingerboard may be engaged as well to perform various maneuvers and tricks. When the user 71 applies pressure to the rear portion 5 in a downward fashion, the rear portion 5 may flex about the release agent 21, such as the hinge 23 or spring mechanism 55, causing the rear portion 5 to flex relative to the adjacent middle portion 6 of the fingerboard and more closely align with the underlying flat surface 43 in which the fingerboard skateboard 1 may be in contact with. The flexion of the rear portion 5 and the pressure thereon may cause the front portion 3 and the middle portion 6 of the fingerboard skateboard 1 to elevate relative to the underlying flat surface 43 unless the user resists such motion with a finger. The user 71 may utilize the first finger 73 to orientate and manipulate the front portion 5 of the fingerboard skateboard 1 in order to perform various stunts and tricks with the skateboard 1 as desired. This includes such tricks requiring the ollie maneuver discussed above with the user's first finger maintaining contact with the front or middle portions of the fingerboard and driving in a forward direction while the rear tail kick portion is released and snaps up off or launches from the underlying surface 43. In such manner, the fingerboard and wheels may be completely elevated off the underlying surface. The fingerboard may be spun or flipped with the user's fingers as well by engaging the different top, bottom, and/or side surfaces.

Specific embodiments and applications of the release agent in the form of a spring click mechanism, spring means, spring mechanism, attachment mechanism, hinge, flexion mechanism, flexible fiber, and/or spring as described herein or similar mechanism have been disclosed with the release agent acting as a loading device and/or as an attachment device or means for attaching one portion of the skateboard deck to another. However, it should be apparent, to those skilled in the art that many more modifications besides those already described are possible without departing from the inventive concepts herein. For example, as explained above, the release agent may be located along any portion of the skateboard deck such as between the nose section and middle section as the fingerboard may be operated in either direction. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A finger operated skateboard toy comprising:
an elongated miniature skateboard deck including a substantially planar main portion and a tail kick portion with each portion cooperating to define a top contact surface providing multiple points of engagement for at least one user's finger to move across to maneuver the skateboard deck and an opposing undersurface defining a wheel mounting surface;
at least one front wheel and at least one rear wheel rotatably coupled to the wheel mounting surface with both wheels being operable to slide or roll over an underlying support surface; and
a release agent disposed proximate at least one of the wheels and flexibly coupling the main portion to the tail kick portion in a pre-loaded configuration, the release agent being constructed to, with both wheels on an underlying surface, be responsive to downward pressure of a user's finger on the tail kick portion to rotate and store energy and, upon subsequent release of the tail kick portion, snap the tail kick portion back to the pre-loaded configuration and launch at least one of the wheels off the underlying surface.

2. The finger operated skateboard toy as set forth in claim 1 wherein:
the release agent is further constructed to increase a normal force between a user's finger engaged with the top contact surface of the main portion of the skateboard deck when the tail kick portion is depressed by the user and also to elevate at least one of the wheels coupled to the main portion of the skateboard deck off an underlying surface when the user's finger is lifted from the top contact surface of the main portion while the tail kick portion is depressed by the user.

3. The finger operated skateboard toy as set forth in claim 1 wherein:
the release agent is constructed to, with a user's first finger engaged with the top contact surface of the main portion and user's second finger depressing the tail kick portion, assist the user in lifting both wheels off an underlying surface to perform a simulated ollie maneuver as the user slides the first finger forward along the top surface of the skateboard deck and momentarily releases the tail kick portion with the second finger.

4. The finger operated skateboard toy as set forth in claim 1 further including:
a plurality of front wheels and a plurality of rear wheels, with the front wheels being rotatably coupled to a front truck and the rear wheels being rotatably coupled to a rear truck with both trucks being coupled to the wheel mounting surface.

5. The finger operated skateboard toy as set forth in claim 1 wherein:
at least one wheel is positioned fore of the release agent and at least one wheel is positioned aft of the release agent.

6. The finger operated skateboard toy of claim 1 wherein:
both wheels are positioned fore of the release agent.

7. The finger operated skateboard toy of claim 1 wherein:
the release agent allows for flexion of the rear portion of the skateboard relative to the main portion of the skateboard.

8. The finger operated skateboard toy of claim 1 wherein:
the release agent includes a pair of spaced apart flexing elements.

9. The finger operated skateboard toy of claim 4 further comprising:
at least one axle attached to the plurality of wheels such that the axle may allow for independent movement of the wheels relative to one another.

10. The finger operated skateboard toy of claim 4 further comprising:
at least one axle attached to the plurality of wheels such that the axle may prevent movement of a pair of wheels relative to one another.

11. The finger operated skateboard toy of claim 1 wherein:
the release agent is a spring.

12. The finger operated skateboard toy of claim 1 wherein:
the release agent spans at least a portion of the width of a break in the skateboard deck between the main portion and the tail kick portion and hingedly couples the portions together, the release agent being constructed to bend from a first position into an alternative position when the top side of at least one of the sections is depressed and snap back to the first position upon release.

13. A method of constructing a finger operated skateboard toy comprising the steps of:
providing a miniature skateboard deck having a front portion and a rear portion with each portion having a top side and a bottom side;
attaching a plurality of wheels to the bottom side of the skateboard deck; and
coupling a release agent to the front portion and to the rear portion with both portions being able to flex relative to one another, the release agent being operable to enable a user to apply a downward pressure with at least one finger to the rear portion of the skateboard deck to elevate the front portion of the skateboard deck and maintain contact with one other finger contacting the front portion of the skateboard deck and further constructed to launch at least one wheel of the skateboard deck off an underlying surface when the user releases finger pressure on the rear portion of the skateboard deck.

14. A method of using a finger operated skateboard toy comprising the steps of:
providing a fingerboard skateboard with a skateboard deck having a front portion and a rear portion with each portion having a top side and a bottom side;
attaching a plurality of wheels to the bottom side of the skateboard deck; and
providing a release agent flexibly coupling the front portion to the rear portion;
placing at least one of the wheels in contact with an underlying support surface;
positioning at least one finger on a top side of the rear portion; and
applying a downward pressure to the top side of the rear portion of the skateboard deck with the at least one finger to elevate the front portion of the skateboard deck and maintain contact with one other finger contacting the front portion of the skateboard deck; and
sliding the other finger in a first direction to lift the skateboard wheels off the underlying surface while maintaining substantial contact between the top side of the skateboard deck and first and second fingers.

15. The method of claim 14, further comprising the step of:
releasing the rear portion of the skateboard deck to launch at least one of the plurality of wheels off the underlying surface.

16. The method of claim 14, further comprising the step of
propelling the fingerboard skateboard over an underlying surface using at least one finger.

17. The method of claim 14, further comprising the step of:
flipping the fingerboard skateboard by engaging at least one finger against the bottom side of the skateboard deck.

18. The method of claim 14, further comprising the step of:
flipping the fingerboard skateboard by engaging at least one finger against the bottom side of the skateboard deck after releasing the rear portion of the skateboard deck.

19. The method of claim 14, further comprising the step of:
steering the front end of the fingerboard skateboard by moving at least one finger engaged with the top side of the skateboard deck in the front portion.

20. The method of claim 14, further comprising the step of:
utilizing a user's fingers to perform various skateboard tricks and stunts with the fingerboard skateboard.
